(19) United States
(12) Patent Application Publication
(10) Pub. No.: US 2007/0273618 A1
(43) Pub. Date: Nov. 29, 2007

(54) PIXELS AND DISPLAY PANELS

(75) Inventors: Meng-Hsun Hsieh, Taichung City (TW); Du-Zen Peng, Jhubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: TOPPOLY OPTOELECTRONICS CORP., Miao-Li County (TW)

(21) Appl. No.: 11/420,511

(22) Filed: May 26, 2006

(51) Int. Cl. G09G 3/30

(52) U.S. Cl. 345/76

(57) ABSTRACT

A pixel providing voltage compensation and comprising a compensation device, a first switch element, a driving transistor, and a display element. The compensation device generates a compensation voltage during a first period. The first switch element transfers a data signal during a second period following the first period. The driving transistor operates in a reverse-bias mode during the first period. The driving transistor operates in a forward-bias mode during the second period to generate a driving current according to the compensation voltage and the data signal. The display element emits light according to the driving current.

### BACKGROUND OF THE INVENTION

1. Field of the Invention

The present invention relates to a pixel, and in particular relates to a display panel.

2. Description of the Related Art

FIG. 1 is a schematic diagram of a panel of a conventional pixel for an organic light emitting display (OLED) device. A pixel 1 comprises a switch transistor M10, a storage capacitor Cst10, a driving transistor M11, and a light-emitting diode (LED) EL. A gate of the switch transistor M10 is coupled to a scan line SL, and a drain thereof is coupled to a data line DL. When the scan line SL is asserted, it provides a scan signal SCAN to turn on the switch transistor M10. A data signal DATA on the data line DL is transmitted to a gate of the driving transistor M11, and the storage capacitor Cst10 stores the data signal DATA. According to the data signal DATA stored in the storage capacitor Cst10, the driving transistor M11 provides a driving current Id to drive the LED EL to emit light. The brightness of the LED EL depends on the amount of driving current Id.

The driving current Id varies by reference of the driving transistor M11. When process deviation of the driving transistor M11 occurs, threshold voltages Vth of the driving transistor M11 in the pixels are different, resulting in non-uniform brightness for pixel-to pixel and/or panel-to panel. Thus, a threshold voltage compensation circuit is important in eliminating non-uniform brightness.

### BRIEF SUMMARY OF THE INVENTION

An exemplary embodiment of a pixel comprises a compensation device, a first switch element, a driving transistor, and a display element. The compensation device generates a compensation voltage during a first period. The first switch element transfers a data signal during a second period following the first period. The driving transistor operates in a reverse-bias mode during the first period. The driving transistor operates in a forward-bias mode during the second period to generate a driving current according to the compensation voltage and the data signal. The display element emits light according to the driving current.

The compensation voltage can be equal to a threshold voltage of the driving transistor. Because the threshold voltage of the driving transistor is compensated by the compensation voltage, the driving transistor can generate the driving current, which is independent of the threshold voltage of the driving transistor, to drive the display device. Thus, the brightness of such a pixel can be independent of the threshold variation, and display uniformity can potentially be improved.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a panel of a conventional pixel for an OLED device;

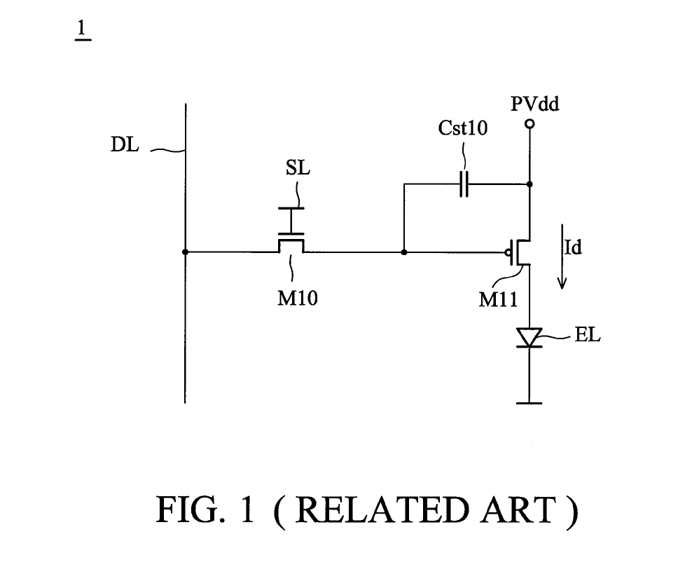

FIG. 2 depicts an embodiment of a display panel;

FIG. 3 depicts an embodiment of a pixel of the display panel in FIG. 2;

FIG. 4 is a timing chart of the embodiment of the pixel of FIG. 3;

FIG. 5 is a schematic diagram of a display device employing the display panel device disclosed in FIG. 2; and

FIG. 6 is a schematic diagram of an electronic device employing the display device disclosed in FIG. 5.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

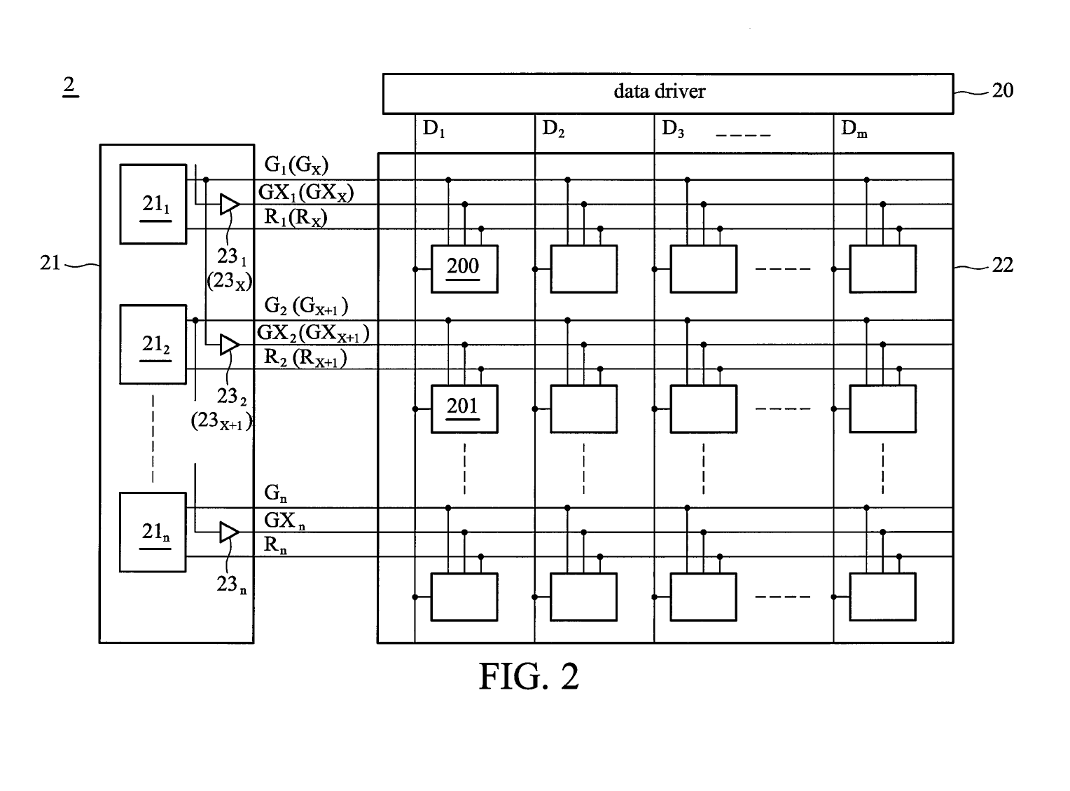

Display panels are provided. In some embodiments, as shown in FIG. 2, a display panel 2 comprises a data driver 20, a scan driver 21, and a display array 22. The data driver 20 controls a plurality of data lines D₁ to Dₘ, and the data lines D₁ to Dₘ respectively carry data signals DATA₁ to DATAₘ. The scan driver 21 comprises a plurality of scan units 21₁ to 21ₙ which respectively controls a plurality of scan lines G₁ to Gₙ, and the scan lines G₁ to Gₙ respectively carry scan signals SCAN₁ to SCANₙ. The display array 22 is formed by intersecting data lines D₁ to Dₘ and scan lines G₁ to G₁. The interlaced data line Dₘ and scan line Gₙ correspond to a display unit, for example, interlaced data line D₁ and scan line G₁ correspond to a pixel 200, and interlaced data line D₁ and scan line G₂ correspond to a pixel 201. Referring to FIG. 2, each scan line Gₓ is further coupled to the pixels in the (x+1)th row through a inverter 23ₓ₊₁. In other words, the pixels in the (x+1)th row receives the scan signal SCANₓ₊₁ on the scan line Gₓ₊₁ and a signal SCANXₓ₊₁, which is reverse to the scan signal SCANₓ, on the reverse scan line GXₙ₊₁, wherein 1≦x≦n−1. For example, the pixel 201 in the second row receives the scan signal SCAN₂ and a reverse scan signal SCANX₂ reverse to the scan signal SCAN₁.

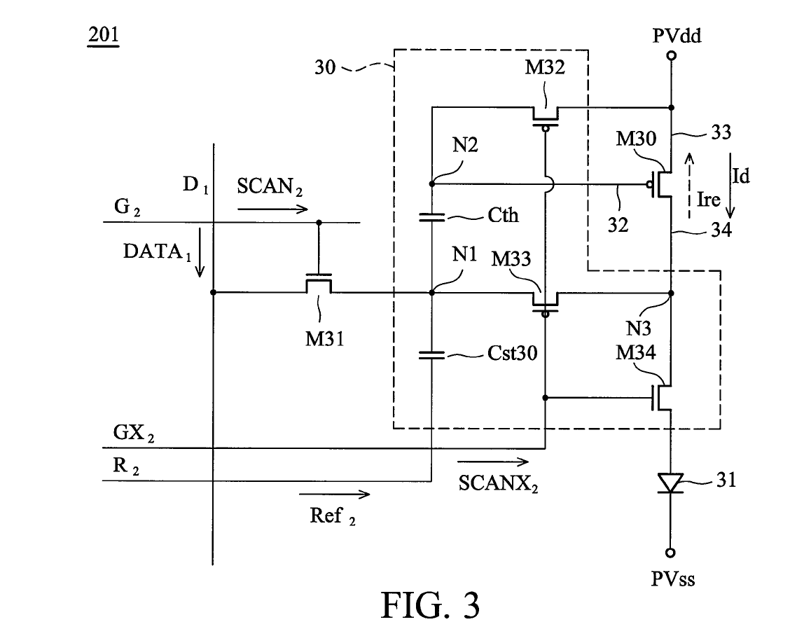

FIG. 3 depicts an embodiment of a pixel in FIG. 2. For each pixel, the pixel 201 operates during a first period and a second period for displaying an image and comprises a driving transistor M30, a compensation device 30, a first switch element M31, and a display element 31. The compensation device 30 generates a compensation voltage during the first period. The first switch element M31 is coupled between the data line D₁ and a first node N1 and controlled by the scan line G₂. When the scan line G₂ is asserted during the second period, the first switch element M31 transfers the data signal DATA₁ to the first node N1. The driving transistor M30 operates in a reverse bias during the first period. The driving transistor M30 operates in a forward bias during the second period to generate a driving current Id according to the compensation voltage and the data signal DATA₁. In FIG. 3, the driving transistor M30 is P-type and has a control terminal 32, a first terminal 33, and a second terminal 34. The first terminal 33 is coupled to a first voltage source PVdd of 5V. In the reverse bias mode, a current Ire from the second terminal 34 to the first terminal 33 is generated. In the forward bias mode, the driving current Id from the first terminal 33 to the second terminal 34 is generated. The display element 31 emits light according to the driving current Id.

Referring to FIG. 3, the compensation device 30 comprises a first capacitor Cst30, a second capacitor Cth, a second switch element M32, a third switch element M33, and a fourth switch element M34. The control terminal 32 of the driving transistor M30 is coupled to the second capacitor Cth at a second node N2, and the second terminal thereof is coupled to a third node N3. The second switch capacitor M32 is couple between the first voltage source PVdd and the second node N2. The fourth switch element M34 is coupled between one terminal of the display element 31 and the third node N3. The third switch element M33 is coupled between the first node N1 and the third node N3. One terminal of the first capacitor Cst30 receives reference signal Ref₂ provided by the scan unit 212 through a reference line R₂, and the other terminal thereof is coupled to the first node N1. The second capacitor Cth is coupled between the second node N2 and the first node N1. The other terminal of the display element 31 is coupled to a second voltage source PVss of −5V. All control terminals of the switch elements M32 to M34 are coupled to the reverse scan line GX₁.

In the embodiment of FIG. 3, the display element 31 can be an electroluminescent element, such as an organic light emitting diode (OLED). The driving transistor M30 can be a thin film transistor (TFT). The switch elements M31 to M34 can be active elements, such as thin film transistors (TFTs). Preferably, the switch elements M31 to M34 and the driving transistor M30 are polysilicon thin film transistors, potentially providing higher current driving capability. In the embodiment of FIG. 3, the switch elements M32 and M33 are P-type TFTs, and the switch elements M31 and M34 are N-type TFTs.

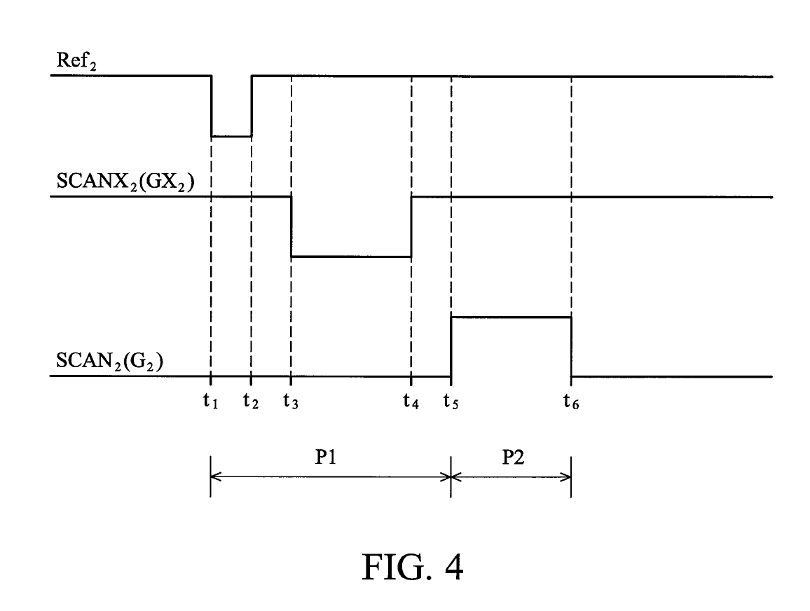

FIG. 4 is a timing chart of the embodiment of the pixel 201 of FIG. 3. In this embodiment, the scan lines G₂ and GX₂ are asserted or de-asserted by the scan unit 212 of the scan driver 21, and the reference signal Ref₂ is provided by the scan unit 212 to function in the manner as described in the following.

During the first period P1, the scan line G₂ is at a low level of 0V (de-asserted). The reference line R₂ is changed from a high level of 10V to a low level of −5V (asserted) at t1 and remains at the low level of −5V from t1 to t2. A voltage Vn1 of the first node N1 is immediately decreased to lower than 0V. In the period from t1 to t2, since the data signal DATA₁ is 0˜5 V and the scan signal SCAN₂ is at 0V, the switch element M31 is turned on slightly, and the first node N1 is, then, charged by the switch element M31 to about −1V˜−2V. At t2, the reference line R₂ is changed from the low level of −5V to the high level of 10V (de-asserted). A voltage of the reference line R₂ rises to 15V, and the voltage Vn1 of the first node N1 is pulled high to about 15V. The reverse scan line GX₂ is changed to a low level (asserted) at t3 and remains at the low level from t3 to t4. According to the reverse scan line GX₂ at the low level, the switch elements M32 and M33 are turned on, and the switch element M34 is turned off. Thus, a voltage Vn3 of the third node N3 is equal to 15V, and a voltage level Vn2 of the second node N2 is equal to 5V. In the period from t3 to t4, the driving transistor M30 operates in the reverse bias mode, and the current Ire from the second terminal 34 to the first terminal 33 is generated. The compensation voltage Vth1 is generated by subtracting the voltage Vn2 from Vn1 and stored in the second capacitor Cth, wherein the compensation voltage Vth1 is equal to a threshold voltage Vth2 of the driving transistor M30.

During the second period P2 from t5 to t6, the reserve scan line GX₂ is at a high level (de-asserted), and the scan line G₂ is at a high level (asserted). The switch elements M32 and M33 are turned off, and the switch element M34 is turned on. The switch element M31 is turned on. The data signal DATA₁ on the data line D₁ has a voltage Vdata. Since the switch element M31 is turned on and the switch elements M32 and M33 are turned off, the data signal DATA₁ is transferred to the node N1 and stored in the first capacitor Cst30 such that the voltage Vn2 of the node N2 is equal to Vdata−Vth1.

The driving current Id flows through the driving transistor M30 with respect to the following relationship:

Id∝(Vsg−Vth2)=(pvdd−Vdata₂+Vth1−Vth2)=(pvdd−Vdata₂)

wherein the source voltage Vₛ of the driving transistor M30 is equal to a voltage pvdd of the first voltage source PVdd, the gate voltage V_{g} thereof is equal to Vdata−Vth1 and the threshold voltage thereof is Vth2.

Accordingly, the driving transistor M30 can generate a driving current Id to drive the display device 31 according to the data signal DATA₁ because the threshold voltage Vth2 of the driving transistor M30 can be compensated by the compensation voltage Vth1 stored in the second capacitor Cth. The driving current Id can drive the display device 31 to emit light because the switch element M34 is turned on.

Since the threshold voltage Vth2 of the driving transistor M30 in this embodiment can be compensated by the compensation voltage Vth1, the driving current Id is independent of the threshold voltage Vth2 of the driving transistor M30. Thus, the brightness of each pixel can be independent of the threshold voltage Vth2. As the brightness of such a pixel can be independent of the threshold variation, display uniformity can potentially be improved.

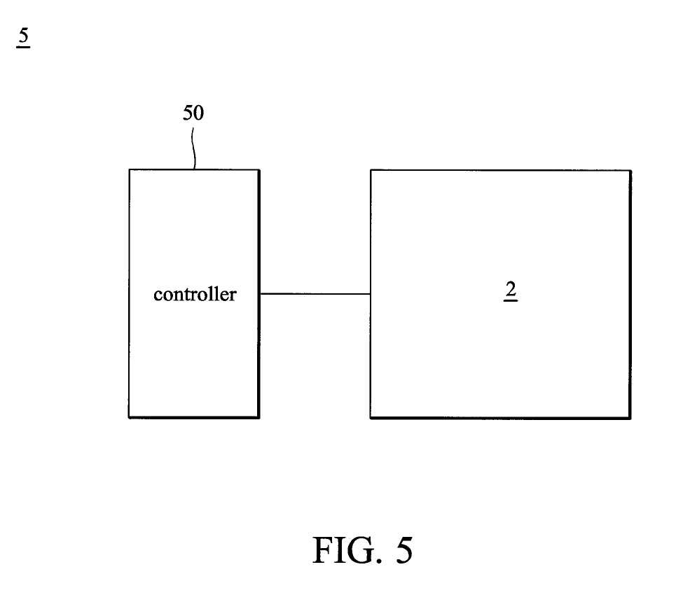

FIG. 5 schematically shows a display device 5 employing the disclosed display panel 2. Generally, the display device 5 includes a controller 50, and the display panel 2 shown in FIG. 2, etc. The controller 50 is operatively coupled to the display panel 2 and provides control signals, such as clock signals, start pulses, or image data, etc, to the display panel 2.

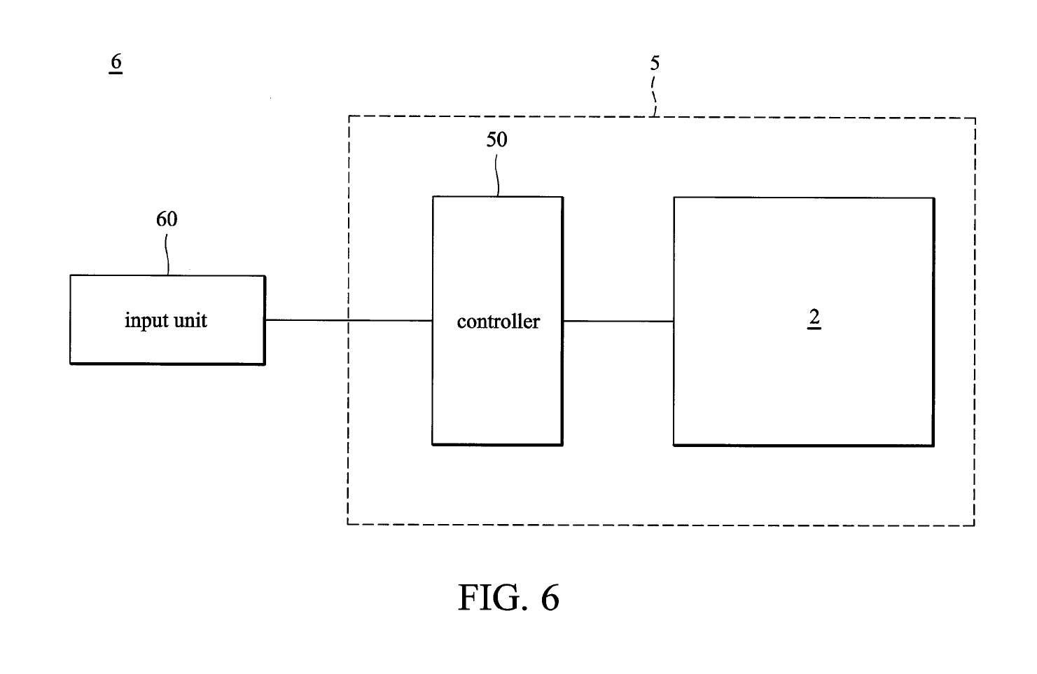

FIG. 6 schematically shows an electronic device 6 employing the disclosed display device 5. The electronic device 6 may be a portable device such as a PDA, digital camera, notebook computer, tablet computer, cellular phone, a display monitor device, or similar. Generally, the electronic device 6 comprises an input unit 60 and the display device 5 shown in FIG. 5, etc. Further, the input unit 60 is operatively coupled to the display device 5 and provides input signals (e.g., image signal) to the display device 5. The controller 50 of the display device 5 provides the control signals to the display panel 2 according to the input signals.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pixel for providing voltage compensation, comprising:
a compensation device generating a compensation voltage during a first period;
a first switch element transferring a data signal during a second period;
a driving transistor operating in a reverse-bias mode during the first period and operating in a forward-bias mode during the second period to generate a driving current according to the compensation voltage and the data signal; and
a display element emitting light according to the driving current.

2. The pixel as claimed in claim 1, wherein the compensation voltage is equal to a threshold voltage of the driving transistor operating in the reverse-bias mode.

3. The pixel as claimed in claim 1, wherein the driving transistor has a control terminal, a first terminal coupled to a first voltage source, and a second terminal.

4. The pixel as claimed in claim 3, wherein during the first period, the compensation device generates the compensation voltage according to a reference signal on a reference line.

5. The pixel as claimed in claim 3, wherein the compensation device comprises:
a first capacitor, wherein one terminal of the first capacitor receives the reference signal, and the other terminal thereof is coupled to a first node; and
a second capacitor coupled between the first node and a control terminal of the driving transistor and storing the compensation voltage.

6. The pixel as claimed in claim 5, wherein the compensation device further comprises:
a second switch element coupled between the first voltage source and the control terminal of the driving transistor;
a third switch element coupled between the first node and the second terminal of the driving transistor; and
a fourth switch element coupled between the second terminal of the driving transistor and the display device;
wherein the second and third switch elements are turned on and the fourth switch element is turned off during the first period, and the second and third switch elements are turned off and the fourth switch element is turned on during the second period.

7. The pixel as claimed in claim 6, wherein the first, second, third, and the fourth switch elements are polysilicon thin film transistors.

8. The pixel as claimed in claim 1 further comprising:
a first scan line coupled to the compensation device and asserted during the first period; and
a second scan line coupled to the first switch element and asserted during the second period.

9. The pixel as claimed in claim 8, wherein the compensation device starts to generate the compensation voltage when the first scan line is asserted, and the first switch element starts to transfer the data signal to the driving transistor when the second scan line is asserted.

10. The pixel as claimed in claim 1, wherein the display element is an electroluminescent element.

11. The pixel as claimed in claim 1, wherein the display element is an organic light emitting diode.

12. A display panel, comprising:
a display array formed by a plurality of data lines and a plurality of scan lines and comprising a plurality of pixels as claimed in claim 1, wherein the scan lines are interlaced with the data lines;
a data driver controlling the data lines; and
a scan driver controlling the scan lines.

13. The display panel as claimed in claim 12, wherein the scan driver further provides a corresponding reference signal to the compensation device of each pixel, wherein the compensation device of each pixel generates the compensation voltage according to the corresponding reference signal.

14. A display device, comprising:
a display panel as claimed in claim 12; and
a controller, wherein the controller is operatively coupled to the display panel.

15. An electronic device, comprising:
a display device as claimed in claim 14; and
an input unit, wherein the input unit is operatively coupled to the display device.

16. The electronic device as claimed in claim 15, wherein the electronic device is a PDA, a digital camera, a display monitor, a notebook computer, a tablet computer, or a cellular phone.
